(19) United States
(12) Patent Application Publication
(10) Pub. No.: US 2008/0172277 A1
(43) Pub. Date: Jul. 17, 2008

(54) ALGORITHMIC FRAMEWORK FOR SCHEDULING STEELMAKING PRODUCTION OPTIMIZING THE FLOW OF MOLTEN IRON SUBJECT TO INVENTORY CONSTRAINTS

(75) Inventors: Andrew J. Davenport, Brooklyn, NY (US); Jayant R. Kalagnanam, Tarrytown, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/623,102

(22) Filed: Jan. 15, 2007

(51) Int. Cl. G05B 19/418

(52) U.S. Cl. 705/8

(57) ABSTRACT

A method of scheduling of the manufacturing operations required to produce cast steel products from molten iron in a steel manufacturing plant.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method of scheduling of the manufacturing operations required to produce cast steel products from molten iron in a steel manufacturing plant.

2. Description of Background

Before our invention a blast furnace is used to heat the iron to a very high temperature, as to become molten. Once the iron is heated, there is a continuous flow of molten iron from the blast furnace to the downstream manufacturing stages. As the molten iron leaves the furnace it begins to cool. As such there is a limited amount of time to move the molten iron from the furnace stage to the final product stage.

In manufacturing processes delays in moving the molten iron can have disruptive consequences. If the liquid metal arrives at a manufacturing stage in an out of range temperature condition, the molten iron may have to be reheated. Reheating iron to return it to the required temperature range uses significant amounts of energy, which may be expensive for the manufacturer.

As more and more manufacturing stages are placed between the furnace stage and the final product stage the complexities in managing the manufacturing process and movement of the molten iron becomes even more complicated.

It is the extreme challenges and a long felt need for a better method of scheduling the manufacturing operations required to produce cast steel products from molten iron in a steel manufacturing plant that in part gives rise to the present invention.

### SUMMARY OF THE INVENTION

The shortcomings of the prior art are overcome and additional advantages are provided through the provision of a method of scheduling manufacturing operations required to produce cast steel products from molten iron in a steel manufacturing plant, the method comprising: generating a detailed schedule for each of a plurality of casts in isolation; producing a high level plan; adjusting the high level plan at coarse level of timing granularity; determining which of the plurality of casts to schedule; determining when a plurality of inventory constraints are satisfied; and generating full detailed schedule of all of the plurality of castings in the high level plan.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which is a method of scheduling of the manufacturing operations required to produce cast steel products from molten iron in a steel manufacturing plant.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a method of manufacturing steel;

FIG. 2 illustrates one example of a Gantt chart illustrating the operations involved in steel manufacturing;

FIG. 3 illustrates one example of the flow of molten iron from the blast furnace to the basic oxygen processes, and the corresponding molten iron (hot metal) inventory level and constraints between these processes;

FIG. 4 illustrates one example of process flow of optimization steps in steel production scheduling; and

FIG. 5 illustrates one example of the planning performed by time indexed mixed integer programming formulation of the high level planning problem.

The detailed description explains the preferred embodiments of the invention, together with advantages and features, by way of example with reference to the drawings.

### DETAILED DESCRIPTION OF THE INVENTION

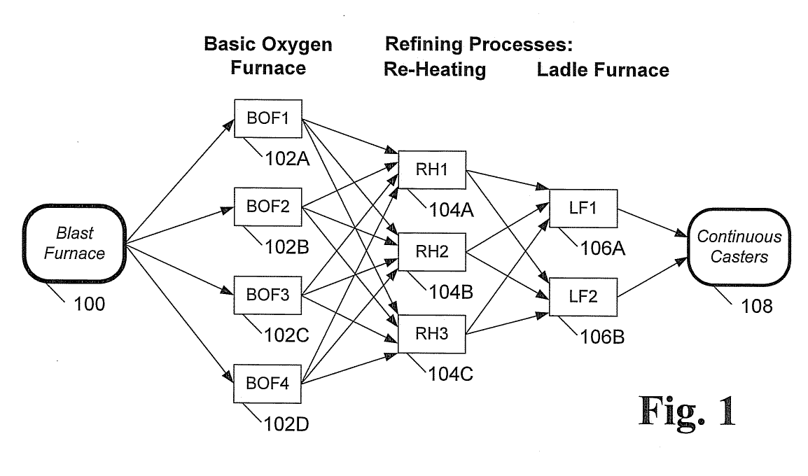

Turning now to the drawings in greater detail, referring to FIG. 1 there is illustrated one example of a method of manufacturing steel. In an exemplary embodiment, a blast furnace 100 is used to heat the iron to a very high temperature, as to become molten. Once the iron is heated, there is a continuous flow of molten iron from the blast furnace 100 to the downstream manufacturing stages.

In an exemplary embodiment, the first manufacturing stage can be a basic oxygen furnace (BOF) 102A-102D. This manufacturing stage is the first stage that all production must pass through after leaving the blast furnace 100. There are usually a number of different available furnaces that can be used in this stage of manufacture (here labeled as BOF1-BOF4). For purposes of disclosure the basic oxygen furnace BOF1-BOF4 can also be referred to as BOF 102A-BOF102D, BOF 102, or basic oxygen furnace 102.

A second manufacturing stage can be refining stages. These refining stages can include steps such as reheating (RH) 104A-104C, ladle furnace (LF) 106A-106B, and stirring (STN) not shown. Not all production will pass through all of these stages. The stages that are used depend on the chemical composition and quality of the final product. For purposes of disclosure reheating (RH) 104A-104C can be referred to as RH 104, or reheating 104. In addition, ladle furnace (LF) 106A-106B can be referred to as ladle furnace (LF) 106, or LF 106.

A final stage can include continuous casting 108. In this final production stage, molten steel is poured into a long, adjustable copper mold. As the steel passes through the mold, it is cooled by water jets and solidifies into casts of a specific dimension.

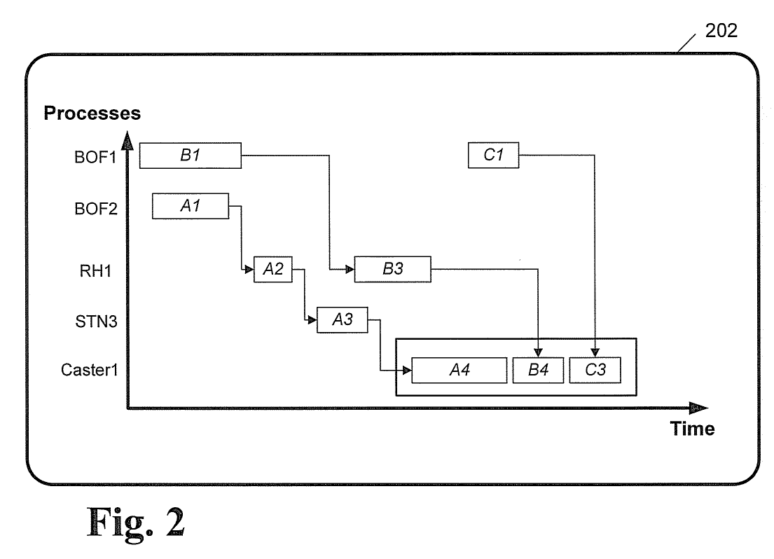

Referring to FIG. 2 there is illustrated one example of a Gantt chart view illustrating some aspects of the present invention with respect to an exemplary embodiment of formulation and scheduling. Illustrated in FIG. 2 is the schedule for the operations involved in the production of a single cast of steel. Each set of operations, for example A1, A2, A3 and A4 in the figure, represent the set of operations required to produce a single ‘charge’ of steel. In operations research terminology, this corresponds to a single job in the scheduling problem.

In the final casting process, a cast is produced which, comprises a sequence of charges. This sequence is given as input to the problem. The scheduling of consecutive charges in a single cast on the casting processes must be continuous. For example, in FIG. 2, there is illustrated three charges A, B, C, which comprises the operations required to produce each charge, {A1, A2, A3, A4}, {B1, B3, B4} and {C1, C3}. On the final casting process, operations A4, B4 and C3 form a single cast. Since the scheduling of operations in the same cast in casting must be continuous, we know that the start time of operation B4 must occur just after the end time of operation A4, and similarly the start time of operation C3 must come just after the end time of operation B4.

There are tight wait time constraints between consecutive operations in a single job, for example {A1, A2, A3, and A4}. This arises because we are scheduling operations on molten steel as it moves through the plant. If we delay the movement of the molten steel between one process and another too long, it begins to cool down. If it cools down too much, it becomes necessary to reheat the steel. This is expensive in terms of energy consumption, so should be minimized. As a result, we have constraints of the form operation A2 must follow operation A1, but the delay between the end of A1 and start of A2 must not exceed 10 minutes.

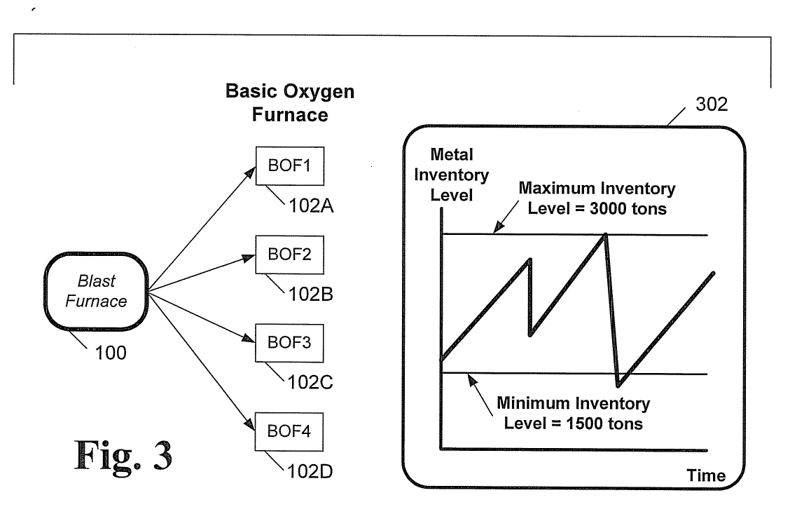

As previously mentioned in the discussion of steel-making processes, there is a continuous flow of molten iron from the blast furnace to the downstream processes. This is specified as a problem input, for example in terms of the number of tons per hour of molten iron flow. This flow of molten iron must be ‘consumed’ by operations that are scheduled in the downstream processes, which transform the molten iron into steel cast products on the casters (we consider some quantity of molten iron to be consumed in the first operation of each job at the basic oxygen furnace process). Between the blast furnace and the downstream processes there is finite capacity buffer, where the molten iron is stored until some operation is scheduled that consumes it. We have inventory constraints on the minimum and maximum quantity of molten iron that can be allowed to accumulate in this buffer. Thus in terms of producing a production schedule for the steel plant, we must be sure to schedule enough operations in the processes downstream of the blast furnace such that these inventory constraints are not violated. FIG. 3 illustrates one example of such constraints. Referring to FIG. 3 there is illustrated one example of the flow of molten iron from the blast furnace 100 to the basic oxygen furnaces 102A-102D, and the corresponding molten iron (hot metal) inventory level and constraints 302 between these processes.

Previously, we presented the basic scheduling model for the production of a single cast. In the full scheduling model of the present invention we are required to schedule many casts on a number (1-12) of distinct casting machines. In addition to the scheduling considerations that need to be taken into account involving the hot metal inventory constraints and the operations of a single cast, we also need to take into account sequence dependent setup times between casts being processed on the same casting machine.

As an example, between the end of processing of one cast and the start of processing of the following cast on the same casting machine, we may need to schedule a setup operation which configures the casting machine for the following cast. The duration of this setup operation may be sequence-dependent, that the duration from cast ‘A’ followed by ‘B’ is not the same as the duration between cast ‘B’ followed by ‘A’.

In addition, with regards to capacity constraints, each charge that is produced in the schedule has a number of attributes, such as product type and grade. We have constraints stating the minimum and maximum number of charges that can be produced per shift, as a function of these attributes.

Solution techniques for solving scheduling problems have been developed in the fields of operations research and computer science. Typical solution approaches include integer programming, constraint programming, local search and genetic algorithms.

In contrast, the difficulty in solving the scheduling problem we have described here is that the scope of the problem, in terms of the constraints, is such that it is not well handled by one solution technology. For instance, the detailed scheduling constraints at the single cast level, as previously described, are handled well by constraint programming, but badly by integer programming. On the other hand, scheduling at a coarse level of time granularity with respect to the hot metal inventory constraints and shift level capacity constraints are handled well by integer programming but badly by constraint programming.

In an exemplary embodiment of the present invention, we propose to decompose the full problem into two sub-problems at different levels of abstraction. Initially, as a high-level planning problem, the solution of this problem determines which casts we are going to schedule during the scheduling horizon, satisfying hot metal inventory constraints, capacity constraints and setup times between casts. We do not consider the scheduling of all refining processes at this stage. This problem is solved with integer programming technology, using a time-indexed integer programming formulation of the problem at a coarse level of time granularity (15-30 minutes of time resolution).

Next, as a low level detailed scheduling problem, we take the solution of the high level-planning problem, and create a detailed schedule at fine level of time granularity (1-30 seconds). We schedule all the processes in the problem, including refining, and consider detailed constraints, which are not considered in the high level problem. This problem is solved using constraint programming technology.

In an embodiment of the present invention, one problem we found when using this approach is that as a result of ignoring the refining processes when solving the high level-planning problem, bottlenecks may occur when we perform the detailed scheduling on the refining processes. In serious cases, this may result in problem infeasibility at the detailed scheduling level. However it is not practical from a solution technology point of view to consider all the refining processes at a detailed level in the high level-planning problem.

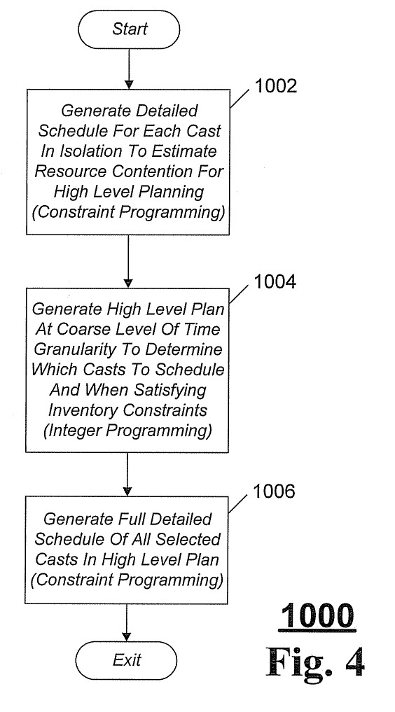

One example of the main process flow for solving the full problem is illustrated in FIG. 4. The goal is to be able to solve the high level-planning problem in a way that does not produce resource bottlenecks on the refining processes once we start detailed scheduling. In order to do this, we need to generate an estimate of what the resource contention will be on the refining processes, for each cast. We build this estimation into the formulation of the high level-planning problem.

In order to generate an estimation of resource contention, we exploit the fact that the schedule for a single cast will be localized in time, as a result of there being tight wait time constraints between the activities in single job (as previously described). We use constraint programming to generate a detailed schedule for each cast in isolation. This detailed schedule will be a feasible schedule for each cast, and will specify the resource utilization at the refining processes, taking into account the detailed scheduling constraints not considered at the high level planning level. Note that when we generate the schedule for a single cast, we do not consider more global constraints, such as hot metal inventory constraints, shift level capacity constraints or constraints between casts.

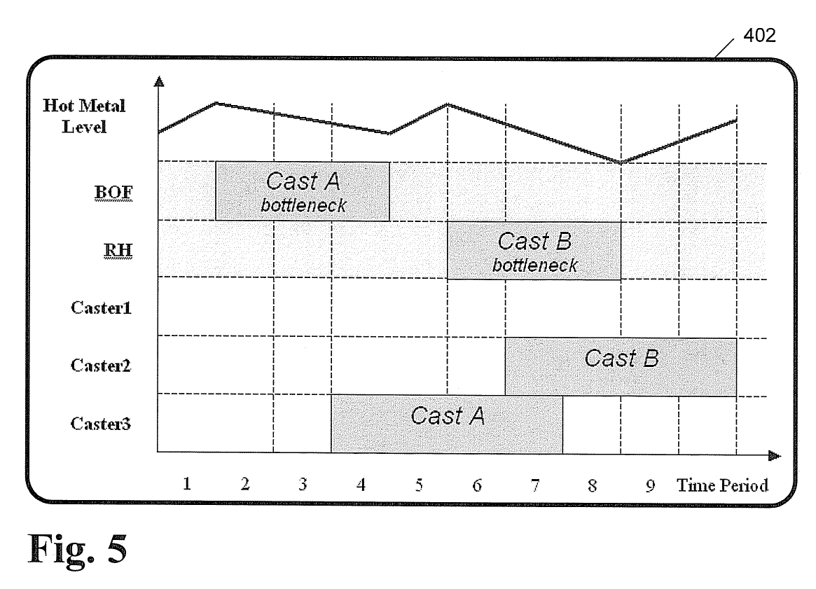

The next stage is then to take these estimations of resource contention for each cast, and build them into the time indexed integer programming formulation of the high level planning problem, along with the global constraints on hot metal inventory, capacity constraints and constraints between casts. The solution to this problem is found using integer programming. Referring to FIG. 5 there is illustrated one example of a time-indexed formulation taking into account bottleneck resource contention 402.

The next stage is to generate the full detailed schedule at a fine level of time granularity. At this stage, the solution to the high level planning problem has specified a coarse schedule which satisfies the constraints on hot metal inventory, capacity constraints, constraints between casts, and is feasible with respect to resource utilization on the refining processes. Constraint programming is used to refine this schedule at the fine level of time granularity, considering detailed job level constraints and assignment of operations to specific machines. The method begins in block 1002.

In block 1002 a detailed scheduled is generated for each cast in isolation to estimate resource contention for high level planning (constraint programming). Processing then moves to block 1004.

In block 1004 a high level plan is generated at a coarse level of time granularity to determine which casts to schedule and when inventory constraints, shift level capacity constraints and setup time constraints are satisfied (integer programming). Processing then moves to block 1006.

In block 1006 a full detailed schedule is generated of all selected casts in high level plan (constraint programming). The routine is then exited.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of scheduling manufacturing operations required to produce cast steel products from molten iron in a steel manufacturing plant, said method comprising:
generating a detailed schedule for each of a plurality of casts in isolation;
producing a high level plan;
adjusting said high level plan at coarse level of timing granularity;
determining which of said plurality of casts to schedule;
determining when a plurality of inventory constraints, shift level capacity constraints and setup time constraints are satisfied; and
generating full said detailed schedule of all of said plurality of castings in said high level plan.

2. The method in accordance with claim 1, wherein producing said high level plan further comprising:
estimating resource contention for said high level plan.

3. The method in accordance with claim 2, wherein said high level plan is effectuated with constraint programming.

4. The method in accordance with claim 3, wherein said plurality of inventory constraints, shift level capacity constraints and setup time constraints are effectuated with integer programming.

5. The method in accordance with claim 4, wherein said plurality of inventory constraints include a maximum inventory constraint, and a minimum inventory constraint.

6. The method in accordance with claim 5, wherein said plurality of inventory constraints are satisfied when metal inventory level is greater than said minimum inventory constraint and less than said maximum inventory constraint.

7. The method in accordance with claim 6, wherein generating full said detailed schedule is effectuated with constraint programming.

8. The method in accordance with claim 7, wherein determining when said plurality of inventory constraints are satisfied further comprising:
waiting until said plurality of inventory constraints are satisfied before preceding.

9. The method in accordance with claim 8, further comprising:
determining a plurality of bottlenecks in said detailed schedule;

10. The method in accordance with claim 9, further comprising:
resolving said plurality of bottlenecks prior to generating full said detailed schedule.

11. The method in accordance with claim 10, wherein generating full said detailed schedule includes generating full said detailed schedule with fine level of time granularity.

12. The method in accordance with claim 11, wherein each of said plurality of casts is manufactured by pouring molten steel into adjustable copper molds.
